(19) United States
(12) Patent Application Publication
(10) Pub. No.: US 2020/0346581 A1
(43) Pub. Date: Nov. 5, 2020

(54) TRAILER TRACKING COMMERCIAL VEHICLE AND AUTOMOTIVE SIDE VIEW MIRROR SYSTEM

(71) Applicants: Jared Lawson, Killdeer, ND (US); Cole Dennis, Killdeer, ND (US)

(72) Inventors: Jared Lawson, Killdeer, ND (US); Cole Dennis, Killdeer, ND (US)

(21) Appl. No.: 16/402,167

(22) Filed: May 2, 2019

(51) Int. Cl. B60R 1/07; B60R 1/12; G01S 7/483; G01S 17/88; G01S 17/06; H04N 13/239; G06T 7/73; G06K 9/00; G06T 7/246

(52) U.S. Cl. CPC B60R 1/07; H04N 2013/0074; G01S 7/483; G01S 17/88; G01S 17/06; H04N 13/239; G06T 7/73; G06K 9/00791; G06T 7/246; B60R 2001/1253; B60R 2300/105; B60R 2300/806; B60Y 2200/147; B60Y 2200/148; B60Y 2400/3015; B60R 2300/8026; G06T 2207/10012; G06T 2207/30252; G06T 2207/30204; B60R 1/12

(57) ABSTRACT

A system for automotive trailer tracking side view mirrors where the side view mirrors are dynamically adjusted to follow and track a trailer, semi-trailer, or other towed load during turning, backing or other maneuvers. The driver is provided with an optimized view of the rear of the trailer without the need to manually adjust side view mirrors. As the vehicle and trailer turn and articulate, the side view mirror system automatically adjusts to turn, rotate, and follow the trailer. The system may provide imaging sensors, digital cameras, Lidar sensors, or other sensor modalities as input to an electronic control module. The control module is provided with image or sensor data regarding the location, angle or orientation of optical markers or targets installed on the trailer. Alternatively, the control module is provided with high resolution imaging or sensor data and applies machine vision and object recognition algorithm to identify the position of the trailer. The control modules provides a control signal output to the side view mirror motors and actuators, to dynamically adjust the side view mirrors, with a frequency response of less than 100 ms in order to provide the driver with a clear unobstructed view.

### BACKGROUND

When reversing or backing up a vehicle with a trailer, the steering wheel must be turned in the opposite direction, than which you want the trailer to go. Back left, turn right; and back right, turn left. Once the trailer begins to turn, the driver must turn the wheel in the other direction to follow the trailer. It is very important to be able to see what is behind the truck, trailer, semi-trailer, tractor-trailer, or load being towed. Rear view mirrors are typically rendered useless by a trailer, boat, or other rig, which obstructs the driver's view from behind. Side view mirrors, which allow the driver to see everything to the side and behind a vehicle, are essential for backing up and towing. Wide, extended side view mirrors, designed for towing are preferred as they allow the driver to see a greater distance behind (as compared with conventional mirrors), and help to eliminate blind spots. Having the side view mirrors adjusted properly allows the driver to clearly see the rear of the trailer. Seeing behind the trailer is the key to backing safely. Both the driver's side and passenger side view mirrors must be used to see behind safely.

Backing slowly, from the best vehicle position and path, while using, scanning, and aggressively checking the side view mirrors on both sides is highly advised. Backing a trailer in a straight line is of course the preferred method, however, sometimes the trailer must be backed up at an angle, a common approach is a right angle backup maneuver. If the driver must backup in a curved path, the preferred approach is to back up towards the driver's side of the vehicle, in order to have a better view of the trailer and see with the driver's side view mirror. When possible, it is advised to reposition the vehicle, and approach the parking spot on the driver's side for backing up. Back up slowly, and make small corrections along the way, in order to avoid getting too far off target. If the trailer or rig starts to drift off the path, turn the steering wheel in the direction of the drift. Pull forward to reposition when needed.

Adjusting side view mirrors to the correct position is essential. The driver should adjust the left and right side mirrors from the perspective of the driver's seat. The side view mirrors should provide a view for a couple hundred of feet behind the vehicle on both sides, as well as the position of the rear of the trailer. Side view mirrors may be adjusted manually, or with power assisted electrical means for vertical and horizontal adjustment from inside the vehicle. Side view mirrors must be adjusted so that the driver can clearly see the rear of the trailer or rig. During backing or turning maneuvers around a right angle, or ninety degree (90°) corner, most side view mirrors become useless, and do not provide a view of the trailer, after a certain point where the trailer or towed load moves out of view. Therefore, a system is needed which automatically tracks and adjusts the side view mirrors to follow the rear of the trailer during trailer backing, turning and parking maneuvers around angles; where the trailer or load moves out view of the side view mirror; around right angles, or around any angle or trailer backing, turning, or parking maneuver, in which the side view mirrors do not adequately provide a view of the trailer.

### SUMMARY

A preferred embodiment of the trailer tracking commercial vehicle, trucking or automotive side view mirror system is an automatically articulated side view mirror or mirrors which follow the rear of the trailer while in reverse, during turning and other maneuvers. The system may use sensors mounted on the rear of the trailer which are linked to the side mirror or mirrors. As the trailer turns or articulates around the hitch point, or fifth-wheel coupling, the side mirror or mirrors automatically articulate, turn, rotate and follow the trailer during backing, turning, parking, or other maneuvers. The position of the side mirror or mirrors is determined by the angle of the trailer relative to the truck or automobile. The sensors mounted on the trailer provide a location towards which the side mirror or mirrors are to be automatically articulated, adjusted and pointed towards, in order to provide the driver with an appropriate field of view of the rear of the trailer.

In a preferred embodiment, the system uses stereo cameras or a stereoscopic camera, or other digital imaging camera, to process and generate an image of the trailer and identify the position and location of the rear end of the trailer. In a preferred embodiment, the system camera tracks an optical target on the trailer during backing, turning or other maneuvers; and the system control module processes and stores data regarding the location, angle, and orientation of the trailer. The system automatically articulates, turns, rotates, adjusts and points the side view mirror or mirrors to follow the rear end of the trailer as identified by the stereo cameras and with output from the system control module. The side view mirrors may be automatically articulated, rotated and adjusted by electronic servo motors or mirror motors to follow the rear of the trailer. The position of the side view mirrors is preferably articulated to provide the driver with an optimized field of view of the rear end of the trailer during backing, turning or parking maneuvers around angles or around corners.

In another preferred embodiment, the system uses Lidar (light imaging, detection, and ranging) to illuminate the rear end of the trailer with pulsed laser light and measures the reflected pulses with a sensor to determine the orientation and location of the trailer. A digital image of the trailer position is then generated and used to automatically articulate, position, rotate, turn and adjust the side view mirrors to follow the rear end of the trailer. In another preferred embodiment, the system uses motion detection and sensors to determine the location and position of the rear of the trailer and appropriately articulate and position the angle of the side view mirrors. The system may preferably use infrared sensors, ultrasonic sensors, multiple surround cameras, radar, sonar, or computer vision to identify and locate the rear of the trailer. Integrated servo motors are preferably used to automatically articulate, rotate, position and adjust the side view mirrors to provide the driver with an unobstructed view of the rear of the trailer during backing, turning, parking and other maneuvers around large corners, or other angles with blind spots.

### DESCRIPTION OF THE DRAWINGS

FIG. 0 is a view of the trailer tracking side view mirror system as deployed in a commercial semi tractor truck application towing a semi-trailer; the semi-truck is equipped with the system controlled and dynamically adjustable side view mirror system for tracking the semi-trailer, and providing the driver with an unobstructed and clear view of the semi-trailer during backing, turning and other maneuvers.

FIG. 5 is a close-up view of the trailer tracking side view mirror system as deployed in a commercial semi tractor truck application; the semi-truck is equipped with the system controlled and dynamically adjustable side view mirror system for tracking the semi-trailer, and providing the driver with an unobstructed and clear view of the semi-trailer during backing, turning and other maneuvers.

FIG. 1 is a view of the trailer tracking side view mirror system as deployed in an automotive light-duty truck application towing an enclosed cargo trailer; a close-up view is provided of the system controlled and dynamically adjustable side view mirror system for providing the driver with an unobstructed and clear view of the trailer during backing, turning and other maneuvers.

FIG. 2 is a driver's side view of the trailer tracking side view mirror system as deployed in an automotive light-duty truck application towing an enclosed cargo trailer; a close-up view is provided of the system controlled and dynamically adjustable side view mirror system for providing the driver with an unobstructed and clear view of the trailer during backing, turning and other maneuvers.

FIG. 3 is a bird's eye view of the trailer tracking side view mirror system as deployed in an automotive light-duty truck application towing an enclosed cargo trailer; the trailer is being maneuvered and backed into a driveway space at an angle; the system controlled and dynamically adjustable side view mirror system is providing the driver with an unobstructed and clear view of the trailer.

FIG. 4 is a bird's eye view of the trailer tracking side view mirror system as deployed in an automotive light-duty truck application towing an enclosed cargo trailer; the trailer is being maneuvered and backed into a driveway space at an angle; the system controlled and dynamically adjustable side view mirror system is providing the driver with an unobstructed and clear view of the trailer.

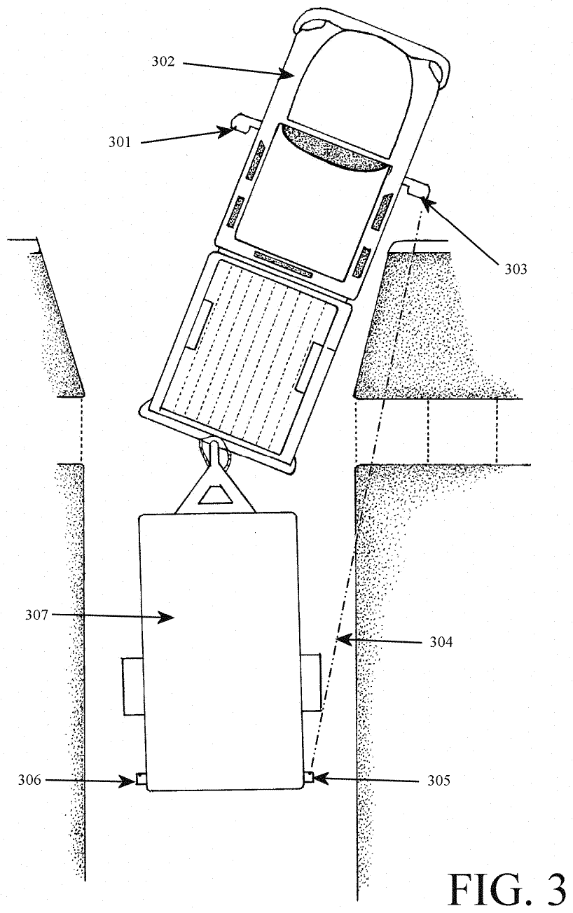

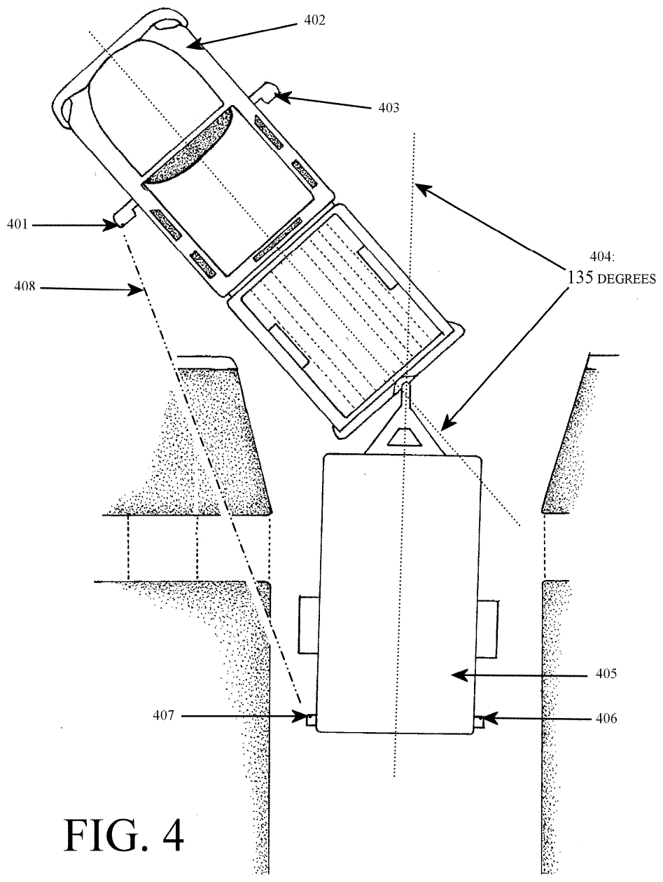

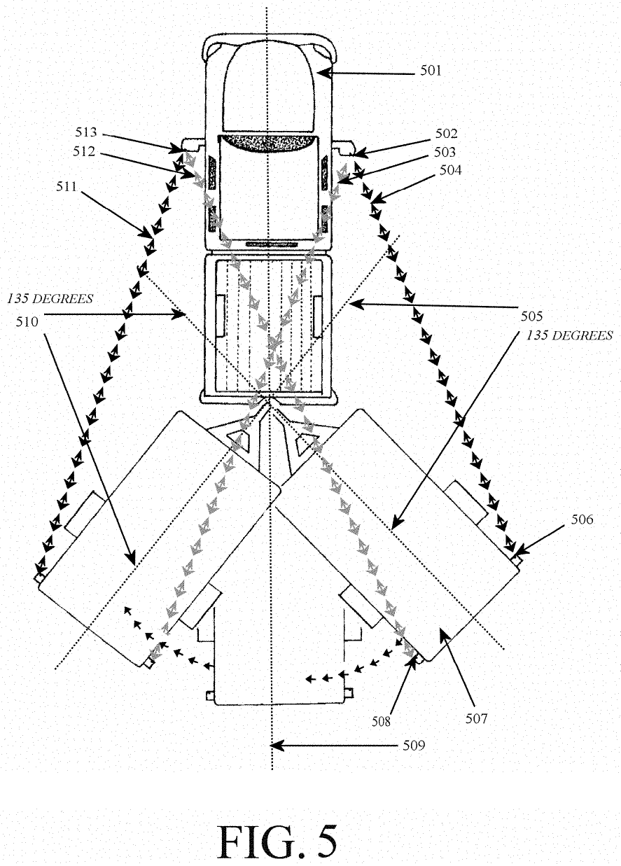

FIG. 5 is a bird's eye view of the trailer tracking side view mirror system as deployed in an automotive light-duty truck application towing an enclosed cargo trailer; the trailer is shown as being maneuvered and backed at multiple angles, from the driver or passenger side; the system controlled and dynamically adjustable side view mirror system is providing the driver with an unobstructed and clear view of the trailer.

### DETAILED DESCRIPTION

The presently described invention is preferably embodied in a commercial vehicle, commercial truck, semi-tractor trailer, automotive, automobile or light-duty truck side view mirror system which automatically follows, the trailer or load being towed, and adjusts position to provide the driver with an unobstructed view of the trailer during turning, reverse, and backing maneuvers. A preferred use case is during trailer backing around a ninety degree (90°) angle corner, as typically the driver's view of the rear of the trailer becomes useless, or obstructed, after a certain point where the trailer or towed load moves out of view. In a preferred embodiment, the system provides a sensor based, automatically adjusting side view mirror system, where a sensor on the rear of the trailer is linked to the side view mirror; and as the driver turns and maneuvers the truck and trailer, the side view mirror follows and re-positions to provide the driver a clear view of the trailer while backing up.

In a preferred embodiment, the system provides at least one sensor mounted to the rear of the trailer to determine trailer angle, position, location and orientation. The sensor may be embodied in an optical target attached to the rear of the trailer. The optical target may be a user installed adhesive sticker, or magnetically affixed object, with a target face reflective surface, or highly visible optical pattern, or other object with a target face light reflective surface or highly visible optical pattern, or other user installed object with an optical target face with identifiable optical elements. In an alternative embodiment, the system may preferably use an optical marker installed on the the trailer to determine trailer position and tracking. The optical marker or target may be embodied in an object with a target face comprised of a high contrast, black and white colored, checkerboard pattern of optical elements, or alternatively optical elements of high contrast squares, triangles, circles, or other shapes and colors, or retroreflective material or surface. The optical marker or target may alternatively be embodied in an active type system, with a visible or non-visible light emitting design. The optical marker or target is observed by the system imaging camera in order to determine the orientation of the target face, with respect to rotation around a three dimensional coordinate system, of X, Y and Z axes. The orientation of the target face is therefore used to determine the relative pitch, yaw, and roll of the trailer with respect to the system imaging camera. The system uses the trailer orientation information and data to automatically adjust and reposition the side view mirrors to provide the driver with a clear view of the rear of the trailer.

In a preferred embodiment, the system uses imaging cameras or sensors with a defined observable area, visual field, or horizontal or vertical field of view, or solid angle or angle of view through which the system optical marker or target is observed. The system preferably uses image sensors to triangulate the three dimensional position of the trailer, and associated optical markers or targets, between two or more imaging sensors or cameras. The system imaging sensors or cameras preferably provide overlapping coverage of the optical markers or targets, which are affixed to the trailer, and generate tracking data of the location, angle and position of the markers and trailer relative to the truck or automobile. The optical imaging system may be embodied with one or more digital camera type imaging devices with a lens and camera configuration that provides a high resolution image of the optical marker or target.

In a preferred embodiment, the system is provided with an electronic control module, comprised of a central processing unit (CPU), motherboard, memory (RAM), non-volatile storage (EEPROM, or NAND flash memory), power supply, and general purpose input/output pins, universal serial bus (USB), or other serial connector and protocol for communication between the system cameras, imaging devices, sensors, and side view mirror adjustment servo motors, mirror motors or actuators. In a preferred embodiment, the system control module, imaging sensors, servo motors, mirror motors and actuators, are plugged into the central network of the vehicle and are able to communicate with other commercial vehicle or automotive vehicle system modules over the CAN bus (Controller Area Network), LIN (Local Interconnect Network), or other vehicle bus network protocol. In a preferred embodiment, the system electronic control module provides functions of sensor input, processing, storage, and output.

The system electronic control module receives input from the imaging sensors or cameras and generates, processes, and stores data regarding the location, position, orientation and angle of the trailer. The system electronic control module provides output regarding the adjustment, repositioning, and horizontal and vertical alignment of the side view mirror motors and actuators. In a preferred embodiment, during trailer backing or turning maneuvers, the system cameras or imaging sensors capture the location and rotational orientation of the optical targets or markers. The cameras and imaging sensors provide input into the system electronic control module regarding the optical target or marker position. The control module then preferably processes, generates and stores data regarding the location, angle, and orientation of the trailer. The position and adjustment of the side view mirror or mirror system is dynamically adjusted by the control module output in order to provide the driver with an unobstructed and clear view of the trailer. Preferably, the side view mirror control signal output is provided with a frequency response of less than one hundred milliseconds (100 ms), to input from the imaging sensors. Preferably, the system electronic control module provides the driver with unobstructed side view mirror positioning during trailer backing or turning around corners greater than the point at which the trailer or towed load moves out of view, and in preferred use cases of trailer backing or turning around ninety degree (90°) corners, right angles, and other angles.

As backup cameras and rear view mirrors are typically obstructed by a trailer or towing load behind the vehicle, the presently described system, which utilizes the side view mirrors, is highly useful for trailer backing and reversing applications. In a preferred embodiment, the system may use wide, extended side view mirrors designed for towing, and providing the driver with the ability to see a greater distance behind (as compared with conventional mirrors), and to help eliminate blind spots. Preferably, the system integrates with extended side view mirror systems and any type of trailer or towing application. In a preferred use case, the system imaging sensors or digital cameras are able to apply machine vision to identify and recognize the rear edge of the trailer or towing load, without the need for the user to install additional optical targets. The system cameras or imaging sensors preferably provide input comprised of high resolution image or images of the position, angle and orientation of trailer or load being towed to the system electronic control module. The control module preferably applies computer vision, machine vision, and object recognition algorithms to processes, generate and store data regarding the position, angle and location of the trailer or load. The extended side view mirrors are dynamically adjusted by the system control module output commands and data to provide the driver with an unobstructed view of the trailer or load during reversing and backing maneuvers, and turning around corners.

In a preferred embodiment, the system provides a driver optimized view of the trailer during turning and backing maneuvers. The driver's eye level position is received from additional vehicle sensors or imaging devices which determine the location of the driver's eye level in the driver's seat. The system electronic control module is provided additional input regarding the location of the driver's eyes and applies further adjustment of the side view mirror motors and actuators in order to provide a driver optimized view in the side view mirrors.

In a preferred embodiment, the system uses Lidar sensors to emit laser light pulses in the direction of the trailer or towed load and record the back scattered or reflected pulses of light to determine orientation, angle and position. The Lidar sensor data is input into the system electronic control module to process, generate and store distance, position, rotation, angle, and other location measurements regarding the trailer or load being towed. The user may install optical targets or markers on the trailer or load in order to aid the system and Lidar detection of location measurements. Alternatively, the system may rely on computer vision, machine vision or object recognition algorithms in order to identify the trailer or load position. The system electronic control module preferably receives the Lidar sensor data as input, applies object recognition algorithms, generates and stores data regarding the trailer location, angle and orientation, and provides output commands to the system side view mirror motors and actuators. The system control module dynamically adjusts the side view mirror or mirror systems to provide the driver with an unobstructed and clear view of the trailer or towed load during backing, reversing, or maneuvering around corners, based upon input from the system Lidar sensors.

In a preferred embodiment, the system may employ either infrared sensors, ultrasonic sensors, multiple surround cameras or imaging devices, radar, or sonar to identify and locate the position of the rear of the trailer, semi-trailer, tractor-trailer or other towed load. The system may use optical targets or markers, or other sensors on the trailer or towed load to assist the system with resolving location and position data. Alternatively, the system may perform location and position processing and calculation, without any optical target, markers or sensors installed on the trailer. In this respect, the system electronic control module will perform trailer location and position calculations with machine vision, object recognition, or other unique sensor signal data pattern recognition algorithms. The system electronic control module preferably receives the infrared sensor, ultrasonic sensor, multiple surround cameras or imaging devices, radar, or sonar data as input, applies object recognition or pattern recognition algorithms, generates and stores data regarding the trailer location, angle and orientation, and provides output commands to the system side view mirror motors and actuators. The system control module dynamically adjusts the side view mirror or mirror systems to provide the driver with an unobstructed and clear view of the trailer or towed load during backing, reversing, or maneuvering around corners, based upon input from the system sensors or imaging devices.

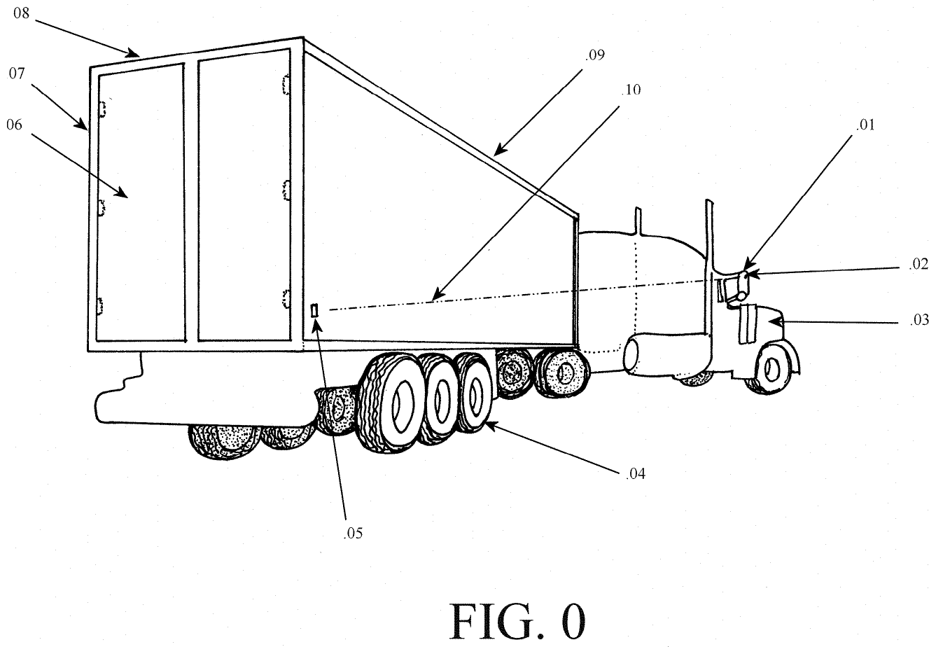

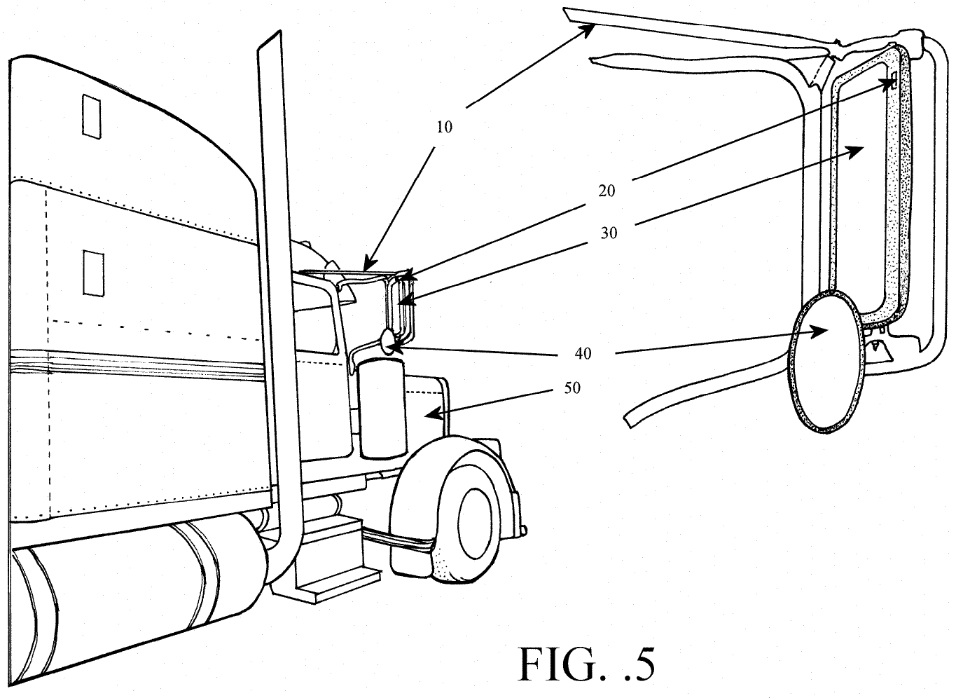

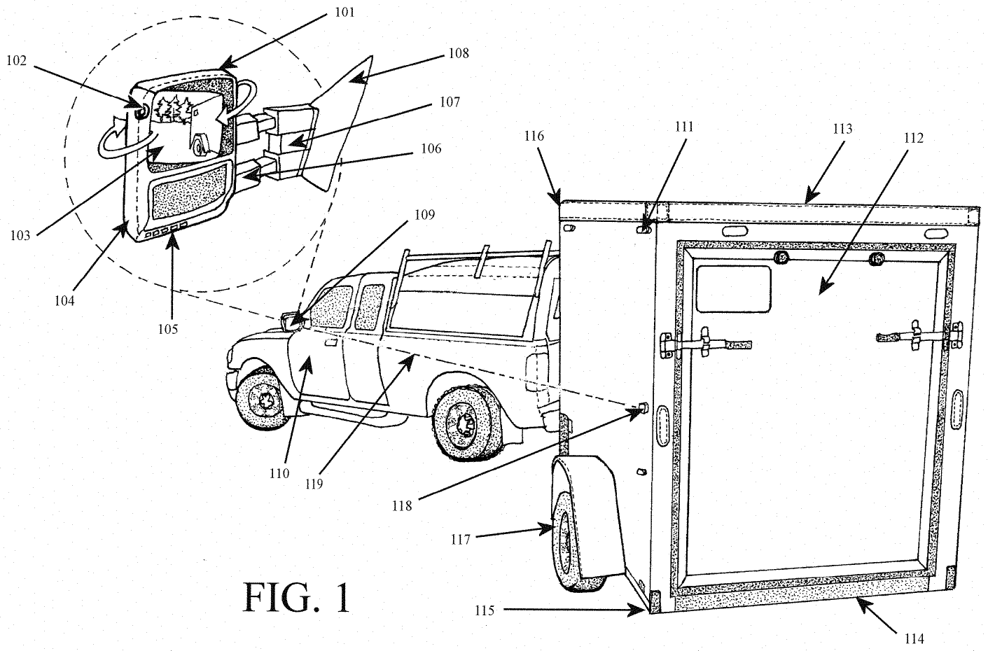

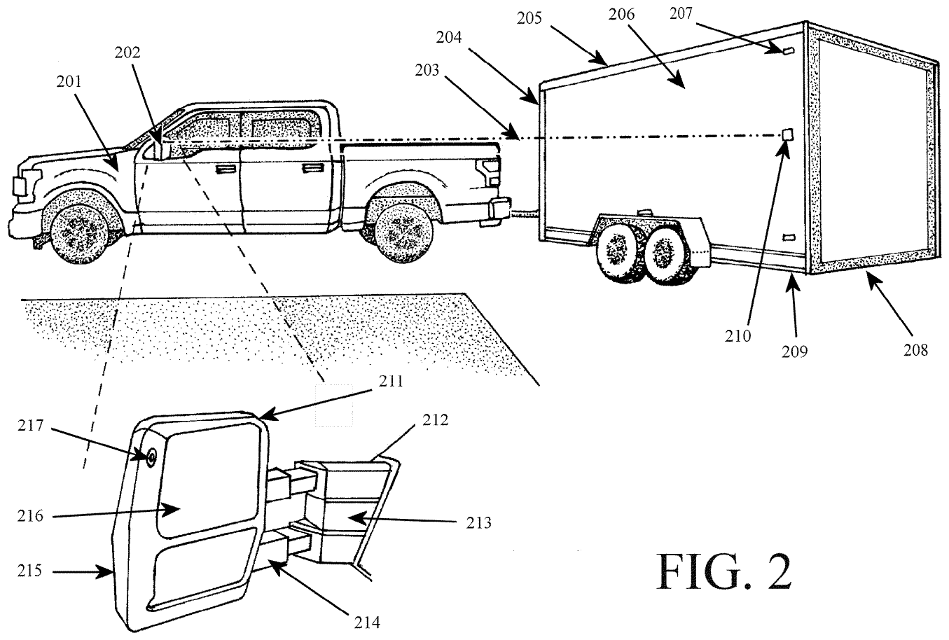

FIG. 0 is a view of a preferred embodiment of the system as deployed in a commercial semi tractor trailer truck application .03 towing a semi-trailer .09. The side view mirror system .01 is dynamically adjusted to follow and track the semi-trailer .05 during turning, backing, reversing, or other maneuvers. The driver is provided an optimized view .01 of the rear of the trailer .10, .05 without the need to manually adjust the side view mirrors. As the commercial semi tractor truck .03 and trailer .09 turn and articulate, the side view mirror system .01 automatically adjusts to turn, rotate, and follow the trailer .05. The system is provided with an imaging sensor .02 as input into the electronic control module. The sensor .02 provides imaging data .10 regarding the location, angle or orientation of the optical marker or target .05. Alternatively, the control module is provided with high resolution imaging or sensor data .02, .10 and applies machine vision and object recognition to identify the position of the trailer and multiple observable trailer surface features .04, .05, .06, .07, .08, and 09. The control module provides a control signal output to the side view mirror motors and actuators, to dynamically adjust the side view mirror .01 in order to provide the driver with a clear unobstructed view.

FIG. 5 is a close-up view of a preferred embodiment of the system as deployed in a commercial semi tractor trailer truck application 50. The side view mirror system 30, 40 is dynamically adjusted to follow and track the semi-trailer during turning, backing, reversing, or other maneuvers. The driver is provided an optimized view 30, 40 of the rear of the trailer without the need to manually adjust the side view mirrors. As the commercial semi tractor truck 50 and trailer turn and articulate, the side view mirror system 30, 40 automatically adjusts to turn, rotate, and follow the trailer. The system is provided with an imaging sensor 20 as input into the electronic control module. The sensor 20 provides imaging data regarding the location, angle or orientation of the optical marker or target; alternatively the control module is provided with high resolution imaging or sensor data and applies machine vision and object recognition to identify the position of the trailer and surface features. The control module provides a control signal output to the side view mirror motors and actuators to dynamically adjust the side view mirror 10, 30, and 40 in order to provide the driver with a clear unobstructed view.

FIG. 1 is a view of a preferred embodiment of the system as deployed in a light-duty truck application 110 and towing an enclosed cargo trailer 112. Any available backup cameras or rear view mirror on the truck 110 would be obstructed by the trailer 116, as the size and height 113 of the trailer blocks the driver's rear view. The side view mirror system 109, is therefore highly useful and essential for trailer backing, reversing, and other maneuvers around corners. Preferably the system integrates with extended side view mirror systems 101, 109 designed for towing, eliminating blind spots and seeing a greater distance behind (as compared with conventional mirrors). In a preferred embodiment, the system imaging sensors or digital imaging cameras 102, 105 observe 119 the optical marker or target 118, as installed on the rear driver's side of the enclosed cargo trailer. The system cameras and imaging sensors 102, 105, observe 119 the optical target 118, and provide input into the system electronic control module regarding the position, angle, location and orientation of the enclosed cargo trailer 112. The control module processes, generates and stores data regarding the angle, and position of the trailer 112, and provides output to the side view mirror system 101, in order to dynamically adjust the mirror 103 and provide the driver with a clear and unobstructed view 103 of the trailer 111, 115, 116, 111, 117, and 118 during backing and other maneuvers. The system side view mirror 101, 103, and 104 is dynamically adjusted by the system control module and mirror motors or actuators as integrated into the side view mirror system 103, 106, 107, and 108.

FIG. 2 is a preferred embodiment of the system as deployed and integrated with a light-duty truck 201 and enclosed cargo trailer application 206. A close up view is provided of the dynamically adjustable side view mirror system 211, and 216, which provides the driver with an unobstructed and clear view of the trailer during backing maneuvers and other use-cases where the trailer 206 articulates at an angle with respect to the truck 201. In a preferred embodiment, the system imaging sensor 217 observers or captures 203 the location and rotational orientation of the optical target or marker 210. In an alternative embodiment, the system electronic control module, with input from the imaging sensor 217, identifies and recognizes 203 the rear edge of the trailer 210, 206, 207, and 209, without the need for an optical target or marker, by applying machine vision, object recognition and other computer vision algorithms. In another alternative embodiment, the system utilizes a Lidar sensor system 217 as input into the control module to process, generate and store distance, position, rotation, angle and other location computations regarding multiple observable trailer surfaces 204, 205, 206, 207, 208, 209 and 210. In a further alternative embodiment, the system employs an infrared sensor, ultrasonic sensor, digital imaging device, radar, or sonar, as integrated in the side view mirror system 217, in order to identify, recognize, and locate the position of the rear of the trailer. The side view mirror system 202, 211, is dynamically adjusted by the electronic control module and integrated servo motors, mirror motors, or actuators 212, 213, and 214 in order to track and follow 203 the rear of the trailer 209, 210, and 207, and provide the driver with a clear and unobstructed view 216.

FIG. 3 is a bird's eye, or unmanned aerial drone view of the system as deployed in a light-duty truck 302 and enclosed cargo trailer application 307. The driver is backing or maneuvering the trailer 307 at an angle from the passenger side, which is typically more difficult than approaching at an angle from the driver's side. The system imaging sensors or cameras, as integrated into the side view mirror system 301, 303, observe 304 the rear edge of the trailer or optical marker or target 305. The imaging device or sensors 303 provide input into the system electronic control module regarding the position and orientation of the trailer 307. The control module processes, generates and stores data regarding the angle, location, and position of the trailer 307. As shown, the passenger side view mirror sensor system 303 observes 304 the trailer rear edge or optical target 305; whereas, the driver side view mirror system 301 and trailer rear edge or optical target 306 is out of range. The control module receives input from both driver and passenger side view mirror system sensors 301, 303, and dynamically adjusts the passenger side view mirror 303 to provide the driver with an unobstructed and clear view of the trailer 304, 305 during the backing, or turning maneuver as shown.

FIG. 4 is a an aerial drone view of the system as deployed in a light-duty truck 402 and enclosed cargo trailer application 405. The driver is turning or backing around a corner from the driver's side, and at an approach angle 404 in which conventional side view mirror systems would not provide a clear view of the trailer. The system imaging sensors, cameras, or other sensors 401, observe and track 408 the trailer 407. The imaging device or sensors 401 provide input into the system electronic control module regarding the position and orientation of the trailer 405, 406 and 407. The control module processes, generates and stores data regarding the angle 404 (i.e., 135 degrees), location, and position of the trailer 307. The control module receives input from both driver and passenger side view mirror system sensors 401, 403, and dynamically adjusts the driver side view mirror 401 to provide the driver with an unobstructed and clear view of the trailer 407 during the backing, or turning maneuver as shown.

FIG. 5 is an aerial drone view of the system as deployed in a light-duty truck 501 and enclosed cargo trailer application 507. The trailer is being maneuvered, turned or backed around an angle 505, 510 (i.e., 135 degrees) at which convention side view mirror systems would be useless. However, the trailer tracking automotive side view mirror system here provides the driver with a clear and unobstructed view of the trailer during the turning, or backing maneuver at an extreme angle 505, 510, at which conventional mirror systems would not be useful. They system imaging sensors, cameras or other sensors 502, 513, provide input into the electronic control module regarding the optical target or marker position, or trailer surface features 506, 508. During turning, backing and maneuvering around corners, or angles, the system imaging sensors, cameras or other sensors 502, 513 dynamically track and follow 503, 504, 511, and 512 the trailer optical target, marker or features 506, 508. The cameras, imaging sensors or other sensor provide input into the system electronic control module regarding the optical target, marker or trailer surface feature location, angle and orientation 506, 508. The control module processes, generates and stores data regarding the imaging sensor input and provides output to the side view mirror motors or actuators to dynamically adjust and provide the driver with a clear view of the trailer during turning or backing maneuvers at extreme angles 505, 510.

The above described system may be applied to commercial trucking, automotive or other vehicle applications in order to provide the driver with an optimized view of the trailer or load being towed, without the need to manually adjust side view mirrors. As deployed in any vehicle application, the side view mirrors are dynamically adjusted to follow and track a trailer, semi-trailer, or other load during turning, reversing, backing or other maneuvers. As the vehicle and trailer turn and articulate, the side view mirror system automatically adjusts to turn, rotate, and follow the trailer. In any vehicle application, the system may preferably provide imaging sensors as input into an electronic control module. The imaging sensor data describes the location, angle, or orientation of the trailer and allows the control module to provide signal output to the side view mirror motors and actuators to dynamically adjust, follow the trailer, and provide the driver with a clear unobstructed view.

1. A system for dynamically positioning side view mirrors to provide the driver with an unobstructed view of a trailer during backing, turning and maneuvering around corners, comprising:
a digital stereo camera with at least two imaging sensors;
an optical marker affixed to the rear of the trailer;
a trailer tracking side view mirror electronic control module; and
a pair of extended side view mirrors with horizontal and vertical adjusting mirror motor actuators;
wherein, the digital stereo camera imaging sensors provide and capture a defined field of view with overlapping coverage of the trailer and optical marker; wherein the electronic control module receives input from the digital stereo imaging sensors and generates location, angle, and position data regarding the trailer; and wherein the electronic control module provides output commands to dynamically position horizontal and vertical adjustment of the extended side view mirrors with the system mirror motor actuators.

2. The system of claim 1 for dynamically positioning side view mirrors, wherein the optical marker is a user installed object with a target face comprised of a highly visible optical pattern, retroreflective surface, or active light emitting design.

3. The system of claim 1 for dynamically positioning side view mirrors, wherein the electronic control module generates trailer location data with respect to the position, angle and rotation of the optical marker around a three dimensional coordinate system.

4. The system of claim 1 for dynamically positioning side view mirrors, wherein the imaging sensors provide an overlapping field of view of the optical marker to the electronic control module for triangulating the three dimensional position of the trailer.

5. The system of claim 1 for dynamically positioning side view mirrors, wherein the imaging sensors, electronic control module, and mirror motor actuators are integrated into a commercial or automotive vehicle bus network protocol for communication with other vehicle modules.

6. The system of claim 1 for dynamically positioning side view mirrors, wherein the trailer tracking electronic control module applies machine vision to identify and recognize the rear edge of the trailer or other load.

7. The system of claim 1 for dynamically positioning side view mirrors, wherein the system uses Lidar sensors to generate data regarding the trailer orientation, angle and position, and to automatically optimize side view mirror adjustment for the driver.

8. A commercial or automotive vehicle system for dynamically tracking a cargo trailer angle and position and automatically adjusting a side view mirror system to provide the driver with a clear view of the trailer during backing and turning maneuvers, comprising:
an integrated imaging sensor system for observing and tracking at least one more more optical targets or markers at the rear of the trailer;
an electronic control module for receiving imaging sensor input, generating and processing trailer angle, position and location data, and providing control signal output to the side view mirror system; and
a side view mirror system with mirror motors and actuators which are dynamically adjusted with control signal output from the electronic control module;
wherein, the integrated imaging sensor system is comprised of two or more imaging sensors or digital cameras with overlapping fields of view which triangulate the three dimensional position of the trailer and optical targets or markers; and wherein, the system imaging sensors, electronic control module and side view mirror motors and actuators are integrated into a vehicle system communication network bus protocol.

9. The system of claim 8 for dynamically tracking a cargo trailer angle and position and automatically adjusting a side view mirror system, wherein the optical targets or markers are user installed objects with a target face comprised of a highly visible optical pattern, retroreflective surface, or active light emitting design.

10. The system of claim 8 for dynamically tracking a cargo trailer angle and position and automatically adjusting a side view mirror system, wherein the imaging sensors and electronic control module apply machine vision to identify and recognize the rear edge of the trailer or other load.

1. The system of claim 8 for dynamically tracking a cargo trailer angle and position and automatically adjusting a side view mirror system, wherein the system uses Lidar sensors to generate data regarding the trailer orientation, angle and position, and to automatically optimize side view mirror adjustment for the driver.

12. The system of claim 8 for dynamically tracking a cargo trailer angle and position and automatically adjusting a side view mirror system, wherein the mirror motor and actuator control signal output from the electronic control module is dynamically generated with a frequency response of less than 100 ms.

13. The system of claim 8 for dynamically tracking a cargo trailer angle and position and automatically adjusting a side view mirror system, wherein the system integrates with extended side view mirror systems designed for towing and eliminating blind spots.

14. The system of claim 8 for dynamically tracking a cargo trailer angle and position and automatically adjusting a side view mirror system, wherein the system imaging sensors generate input into the control module to process, generate and store distance, position, rotation, angle and other location computations regarding multiple observable trailer surface features.

15. A system for dynamically tracking a commercial vehicle or automotive trailer and adjusting a side view mirror system to provide the driver with a clear and unobstructed view of the trailer during turning and backing maneuvers, comprising:
a network of one or more imaging sensor devices;
an electronic control module for receiving input from the network of imaging sensors;
and
a side view mirror system with computer controlled mirror motors and actuators;
wherein, the network of imaging sensors observe the trailer and provide the electronic control module with high resolution images of trailer surface features; wherein the electronic control module processes the imaging sensor data and applies machine vision object recognition algorithms to detect the location, position, angle and orientation of trailer surface features; and
wherein, the side view mirror motors and actuators are automatically adjusted to provide the driver with an optimized view in response to trailer surface feature position data.

16. The system of claim 15 for dynamically tracking a commercial vehicle or automotive trailer and adjusting a side view mirror system, wherein the system uses Lidar sensors to generate data regarding the trailer orientation, angle and position, and to automatically optimize side view mirror adjustment for the driver.

17. The system of claim 15 for dynamically tracking a commercial vehicle or automotive trailer and adjusting a side view mirror system, wherein the mirror motors and actuators are adjusted with a control signal output from the electronic control module which is dynamically generated with a frequency response of less than 100 ms.

18. The system of claim 15 for dynamically tracking a commercial vehicle or automotive trailer and adjusting a side view mirror system, wherein the system integrates with extended side view mirror systems designed for towing and eliminating blind spots.

19. The system of claim 15 for dynamically tracking a commercial vehicle or automotive trailer and adjusting a side view mirror system, wherein the system imaging sensors generate input into the control module to process, generate and store distance, position, rotation, angle and other location computations regarding multiple observable trailer surface features.

20. The system of claim 15 for dynamically tracking a commercial vehicle or automotive trailer and adjusting a side view mirror system, wherein the driver optimized view is determined by driver eye level position.
